(19) United States
(12) Patent Application Publication
(10) Pub. No.: US 2016/0131491 A1
(43) Pub. Date: May 12, 2016

(54) Interactively Scheduling an Itinerary

(71) Applicant: Reservation Counter, LLC, Lehi, UT (US)

(72) Inventors: Daniel A. Nelson, Lehi, UT (US); Ryan Williams, Lehi, UT (US); Ryan McCoy, Lehi, UT (US); Neil Valentine, Lehi, UT (US); Steven Dalley, Lehi, UT (US); Bradley P. Pace, Lehi, UT (US)

(73) Assignee: Reservation Counter, LLC, Lehi, UT (US)

(21) Appl. No.: 14/938,473

(22) Filed: Nov. 11, 2015

Related U.S. Application Data
(60) Provisional application No. 62/078,305, filed on Nov. 11, 2014.

(51) Int. Cl. G01C 21/34

(52) U.S. Cl. CPC G01C 21/343

(57) ABSTRACT

An itinerary can be scheduled interactively by assisting a user in identifying which destinations or attractions can be visited during a vacation based on a specified location where the user intends to be during the vacation. A database of information about each possible destination or attraction as well as about available transportation between such destinations and attractions can be maintained. This information can identify many different criteria that can be used to determine whether it would be desirable or feasible for the user to visit the destination or attraction based on an intended location of the user. The information can be compiled based on input from locals or other experts that are familiar with the destinations or attractions. Once an itinerary is scheduled, reservation requests can be automatically generated for any destination and/or mode of transportation that was selected for inclusion in the itinerary.

### CROSS-REFERENCE TO RELATED APPLICATIONS

This application claims priority to U.S. Provisional Patent Application No. 62/078,305 filed Nov. 11, 2014.

### BACKGROUND

When people travel to new places, they oftentimes rely on a travel agency to assist them with scheduling their itinerary. Typically, a travel agency will provide a few set itineraries for a particular location from which travelers may select. Because such itineraries are set, the travelers have little flexibility to choose the destinations or attractions they will visit and when they visit them. For example, many travel agencies offer itineraries that start and end on the same days of the week throughout the year and that include the same destinations and attractions.

Due to the lack of flexibility provided by many travel agencies, some travelers will try to schedule their own itinerary. This can result in many problems. For example, because travelers are oftentimes unfamiliar with the area they plan to visit, they will rely on information about the area that they can find online or from printed sources. Such information can be helpful for obtaining a general understanding of what attractions are available in the area. However, from such information alone, it can be difficult to arrange an itinerary for visiting selected attractions. Without local knowledge of the attractions, including knowledge of the travel time between attractions, the availability of transportation between the attractions, the hours when the attraction can be visited, the amount of time one should plan to spend at the attraction, etc., a traveler may put together an itinerary that ends up being undesirable or possibly even unfeasible.

### BRIEF SUMMARY

The present invention extends to methods, systems, and computer program products for interactively scheduling an itinerary. The present invention can assist a user in identifying which destinations or attractions can be visited during a vacation based on a specified location where the user intends to be during the vacation. The present invention can compile a database of information about each possible destination or attraction as well as about available transportation between such destinations and attractions. This information can identify many different criteria that can be used to determine whether it would be desirable or feasible for the user to visit the destination or attraction based on an intended location of the user. The information can be compiled based on input from locals or other experts that are familiar with the destinations or attractions.

A user may initiate the process of interactively scheduling an itinerary by inputting a starting location such as an airport of arrival. Then, based on this starting location and the compiled information about destinations and attractions, the present invention can present the user with recommendations of the destinations and attractions that would be desirable and/or feasible as the next stop in the itinerary. The present invention can also present various transportation options for traveling to the recommended destinations and attractions. The desirability or feasibility of a particular destination or attraction can be based on many different criteria including, for example, the travel time to the destination or attraction, the time of day when the user will be at the starting location, the availability of transportation to the destination or attraction from the starting location, the hours of operation of the destination or attraction, etc.

Once the user selects a destination or attraction as the next stop in the itinerary, the process can be repeated with the selected destination or attraction acting as the new starting location. After the user has selected each stop of the itinerary, the present invention can identify each destination, attraction, and means of transportation for which a reservation or purchase may be required and automatically request the reservation or make the purchase. In this way, the user can have great flexibility when scheduling an itinerary while also receiving guidance to ensure that the itinerary is desirable and feasible.

In some embodiments, rather than scheduling destinations in a sequential manner, the user can specify one or more destinations that he or she would like to visit including possibly when he or she would like to visit them. Alternatively, the present invention can assist the user in identifying a particular time when such destinations can or should be visited. Then, the remaining destinations can be added to the itinerary taking into account both a starting location, date, and time as well as a subsequent location, date, and time. Accordingly, the interactive scheduling of an itinerary can be performed in both a sequential and a non-sequential manner.

In one embodiment, the present invention is implemented as a method, performed by a server computing system in communication with a user computing device, for interactively scheduling an itinerary. For each of a plurality of destinations, the server computing system can store information which identifies a starting point with which the destination is related and one or more criteria for visiting the destination from the starting point. Input can be received from the user computing device which defines a user's starting point and a starting date and starting time when the user will be at the starting point. The stored information for each of the plurality of destinations can be accessed to identify one or more destinations that are related to the user's starting point. For each of the one or more destinations that are related to the user's starting point, the starting date and starting time can be compared to the one or more criteria for visiting the destination to identify whether the destination can be a next destination after the user's starting point based on the starting date and starting time. For each destination that can be the next destination after the user's starting point based on the starting date and starting time, a recommendation to visit the destination can be displayed. User input can be received that selects a recommendation to visit a first destination. The first destination can then be added to an itinerary for the user such that the itinerary defines that the first destination is the next destination after the starting point.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing environment in which the present invention can be implemented;

FIGS. 2A-2K illustrate various example views of a website that can be provided to allow users to interact with embodiments of the present invention;

FIGS. 3A-3C illustrate various example data structures that can be stored and accessed in implementations of the present invention;

FIG. 4 illustrates an example of how a server system can automatically generate reservation requests based on a user's scheduled itinerary; and

FIG. 5 illustrates a flowchart of an example method for interactively scheduling an itinerary.

### DETAILED DESCRIPTION

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

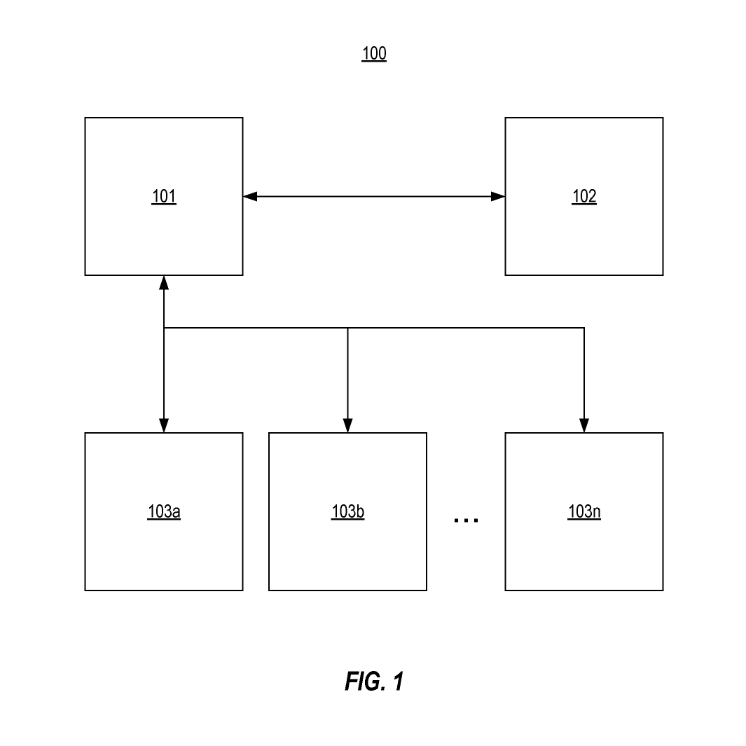

FIG. 1 illustrates an example computer environment 100 in which the present invention can be implemented. Computer environment 100 includes a server system 101, a user computing device 102, and a number of provider systems 103a-103n. Server system 101 represents the computing system that provides the functionality of the present invention. For example, server system 101 may host a website with which a user may interact to interactively schedule an itinerary. Server system 101 may include or otherwise be in communication with a database which stores information about a number of attractions, destinations, and modes of transportation which can be used to assist a user in scheduling an itinerary.

In this specification, a destination or attraction (which will hereinafter be referred to simply as a destination) can be any location to which a user may desire or need to visit. For example, a destination can include a location that provides overnight accommodations (e.g., a hotel, a hostel, a campground, a rental home, etc.), a tourist attraction (e.g., a historic site, a national park, an entertainment venue, etc.), an event (e.g., a convention, a sporting event, a concert, etc.), a travel hub (e.g., an airport, a bus terminal, a port, etc.) or virtually any other location that people may desire to visit. A mode of transportation can be any means for travelling from one destination to another regardless of the type of vehicle (or lack thereof) used to travel including, for example, taxis, buses, trains, airplanes, boats, bicycles, foot, etc.).

User computing device 102 represents any type of computing device or system that a user can employ to communicate with server system 101 for the purpose of scheduling an itinerary. For example, user computing device 102 can represent a desktop or laptop computer, a mobile phone, a tablet, a television, or other device used to communicate over a network such as the internet.

Provider systems 103a-103n can represent any of the computing systems or devices employed by a destination, transportation provider, or their agents to receive reservation requests. A reservation request should be construed broadly to encompass any type of request to visit an attraction or to use a mode of transportation. For example, one provider system can represent a server system employed by a hotel chain to create and maintain reservations, another provider system can represent a server system employed by a national park to receive requests for tickets, and another provider system can represent a server system employed by a bus service for selling bus fares.

As an initial overview of embodiments of the present invention, server system 101 can provide a website or other interface through which a user, via user computing device 102, may interact to receive guidance and recommendations for scheduling an itinerary. In some embodiments, once a user has completed scheduling an itinerary, server system 101 can automatically send reservation requests to the appropriate provider systems. A primary benefit of the present invention is that a user can interactively schedule a desirable and feasible itinerary without needing significant or even any prior knowledge of the destinations to be visited while still retaining the flexibility provided by independently scheduling the itinerary.

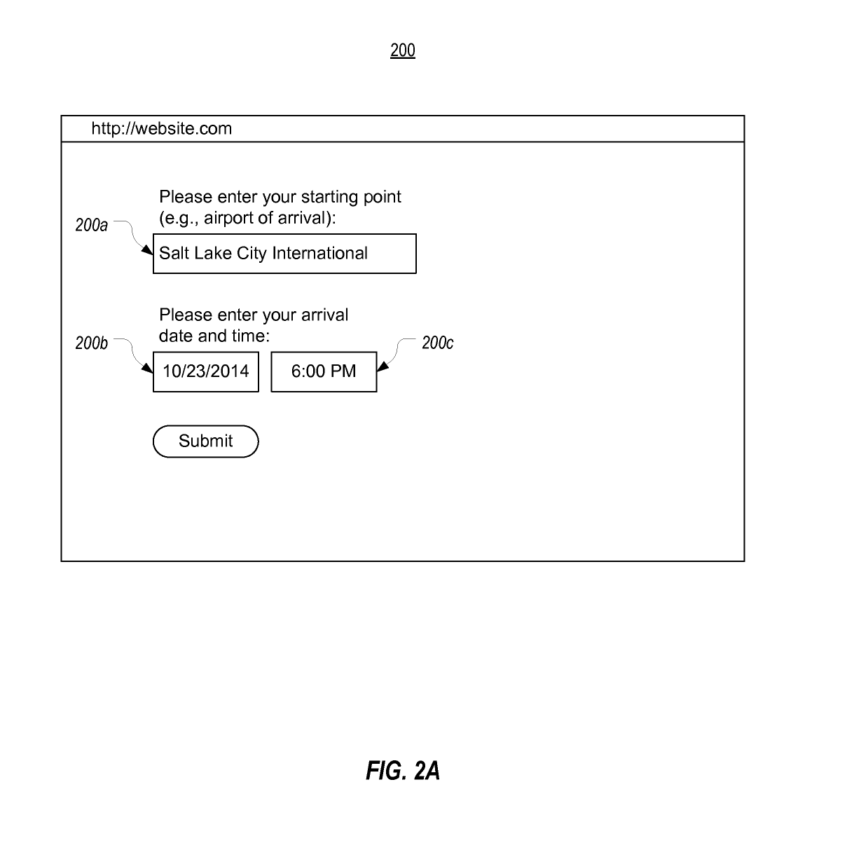

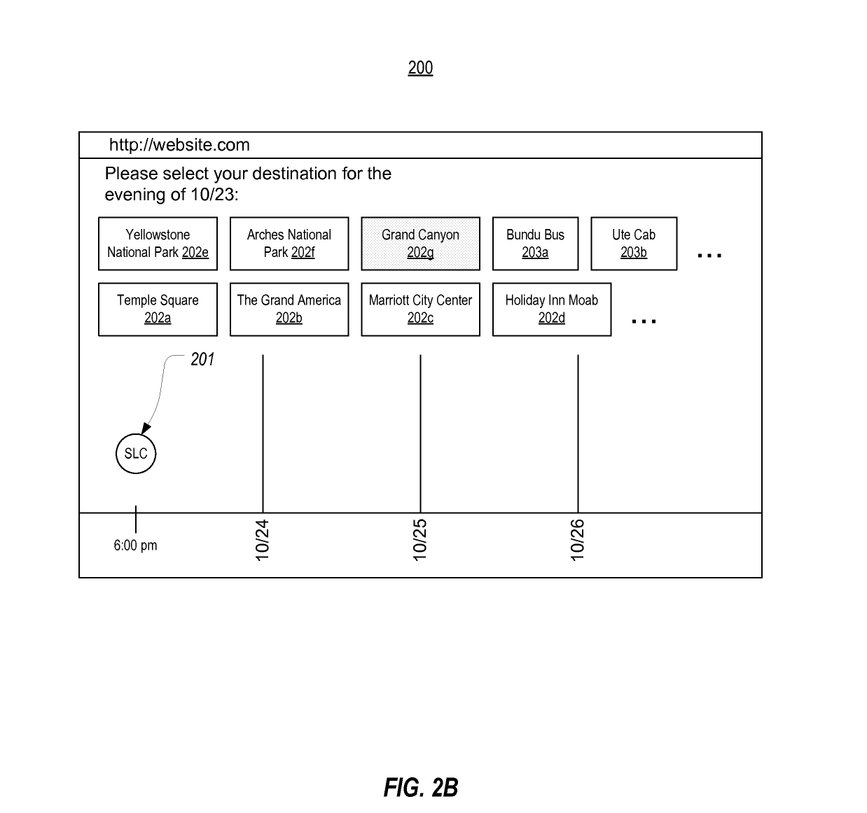

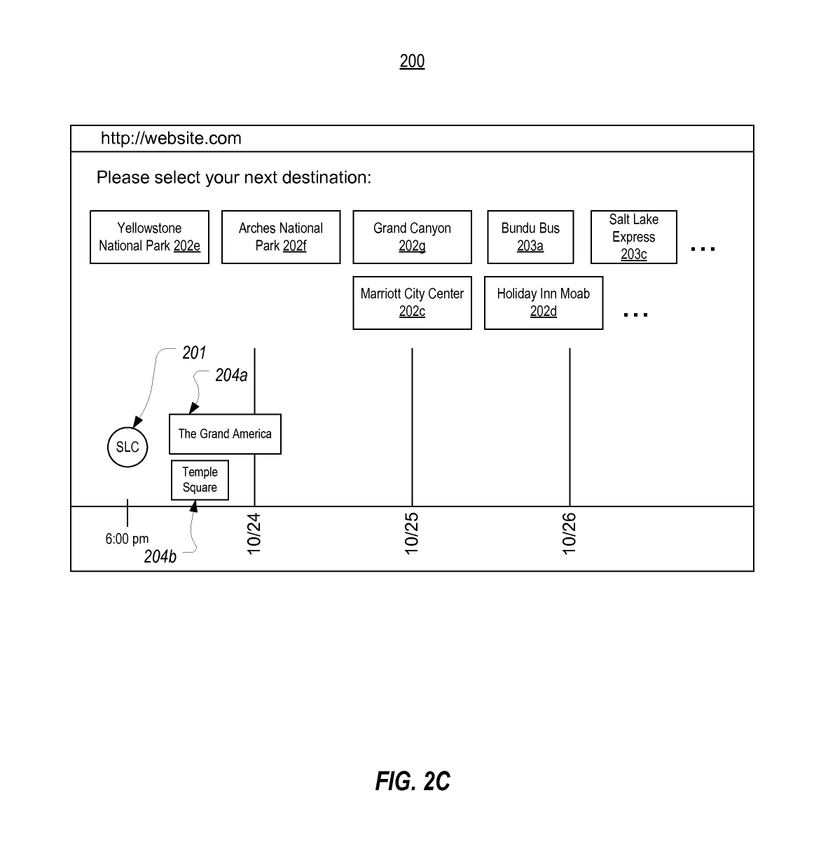

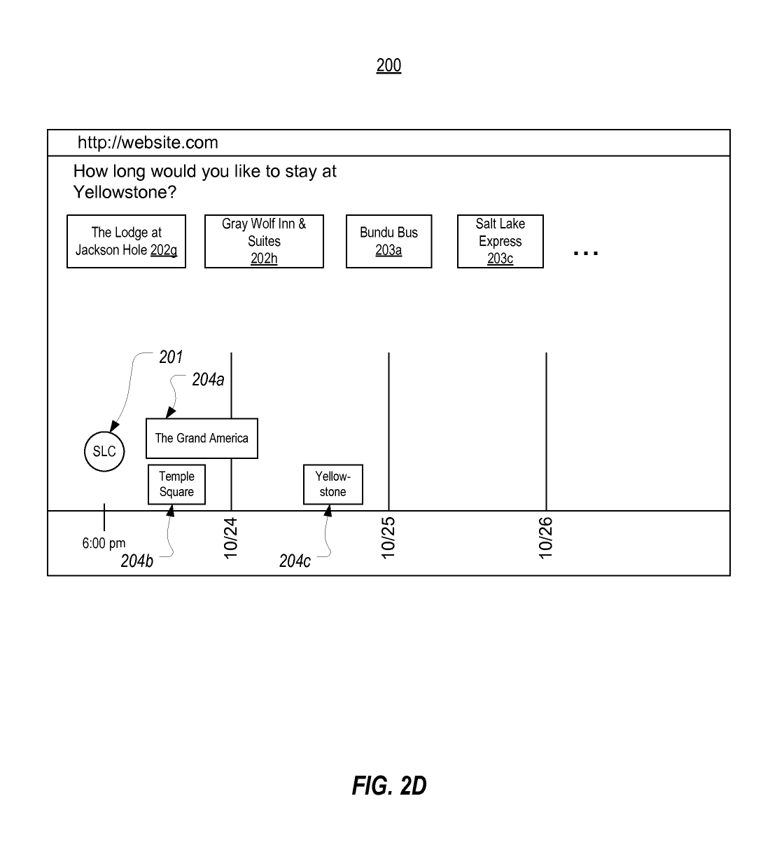

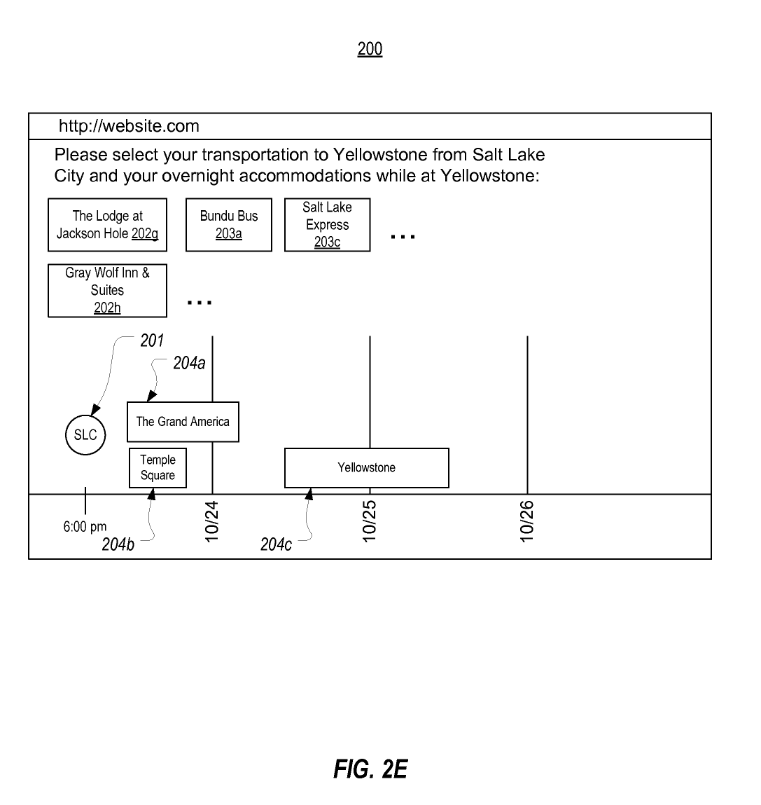

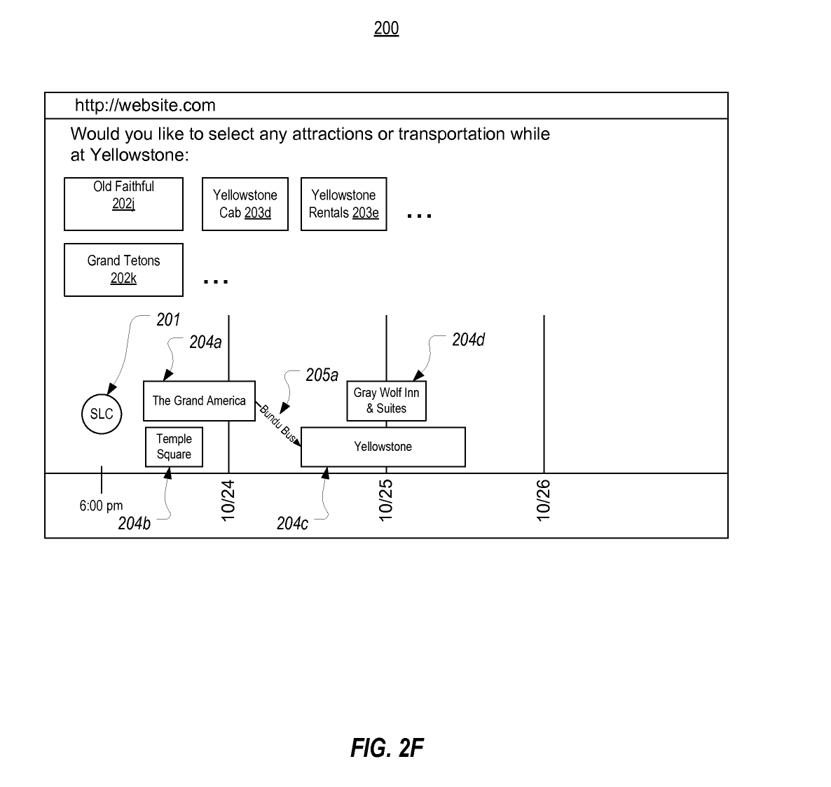

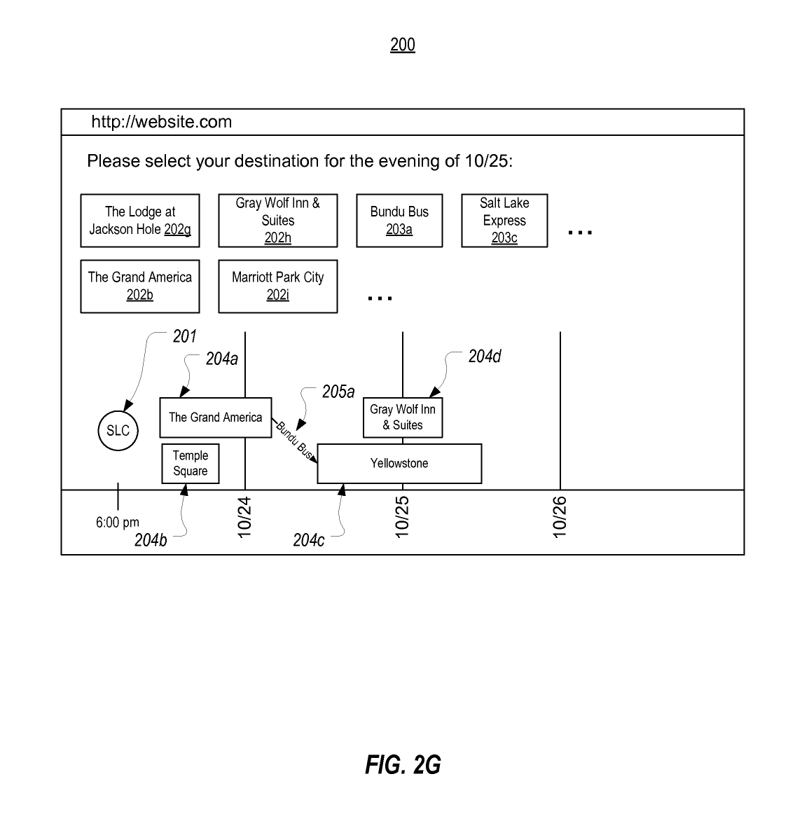

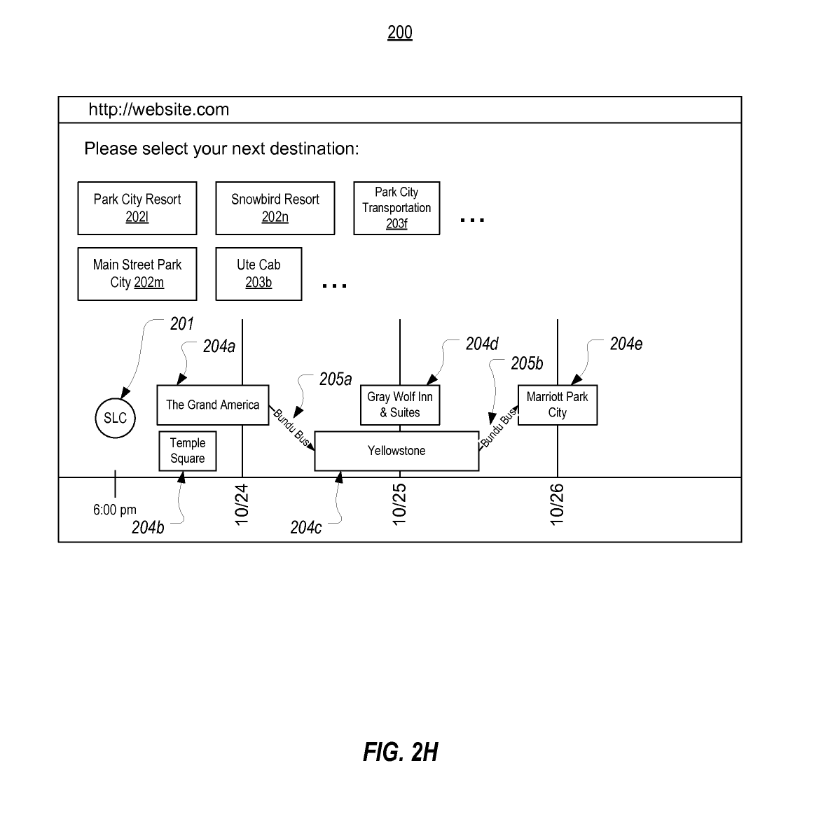

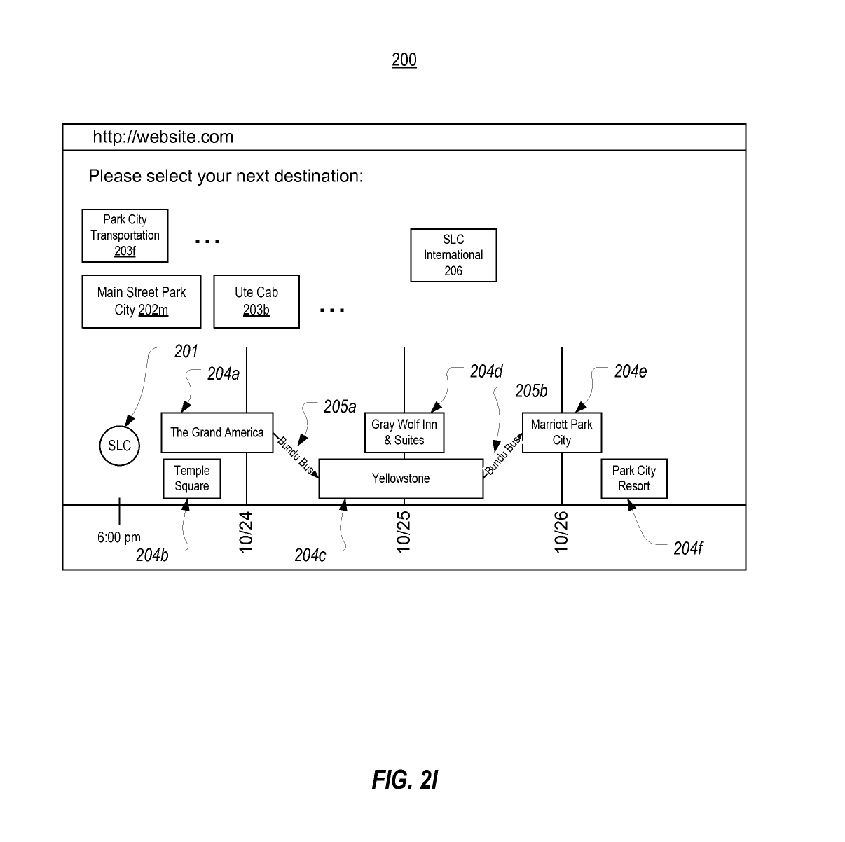

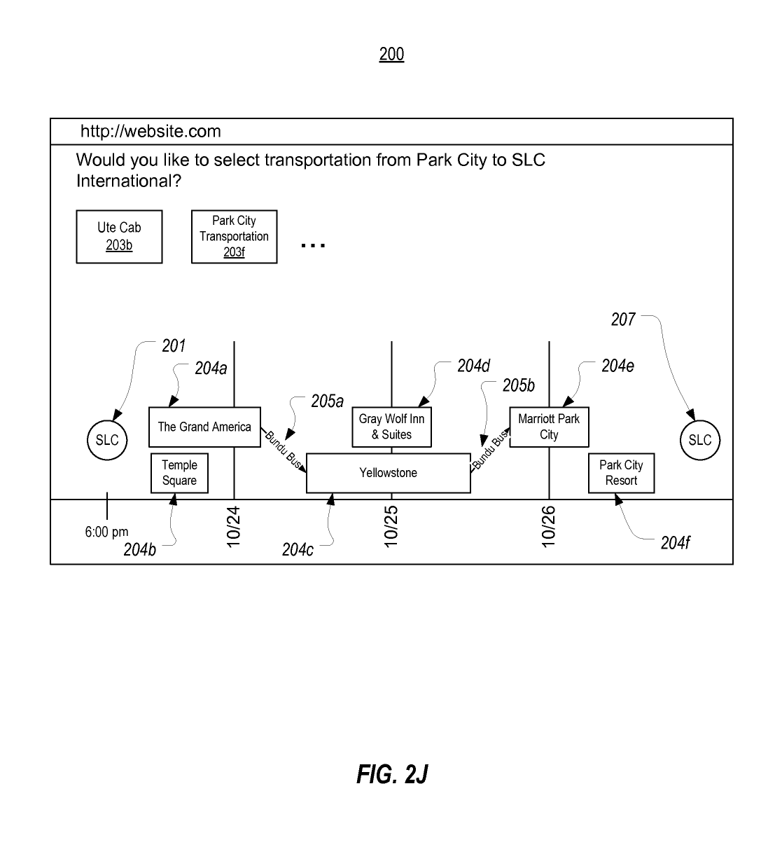

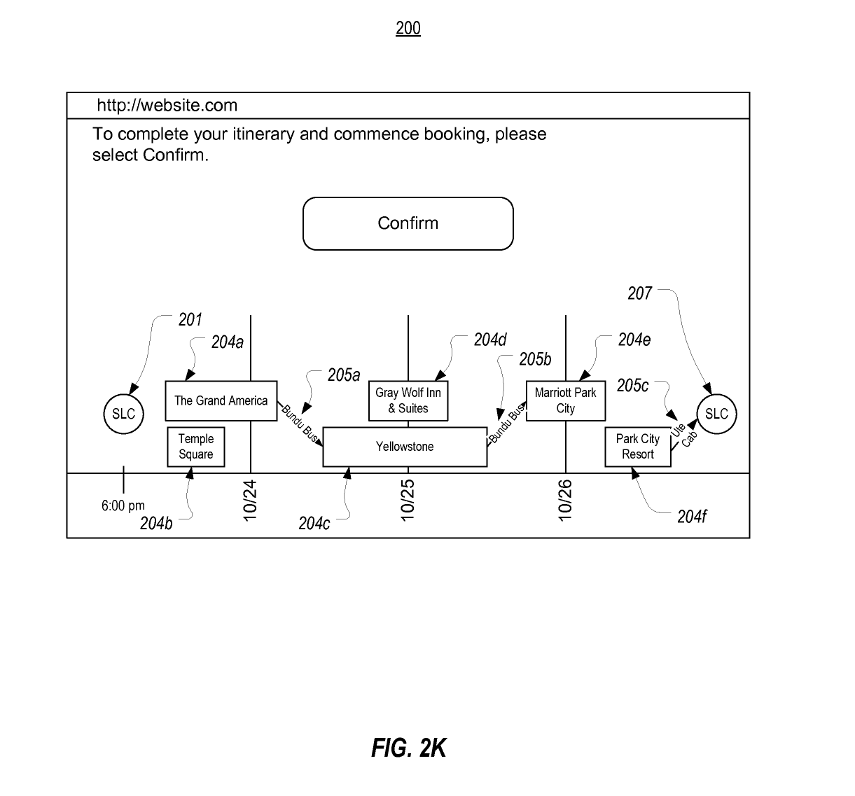

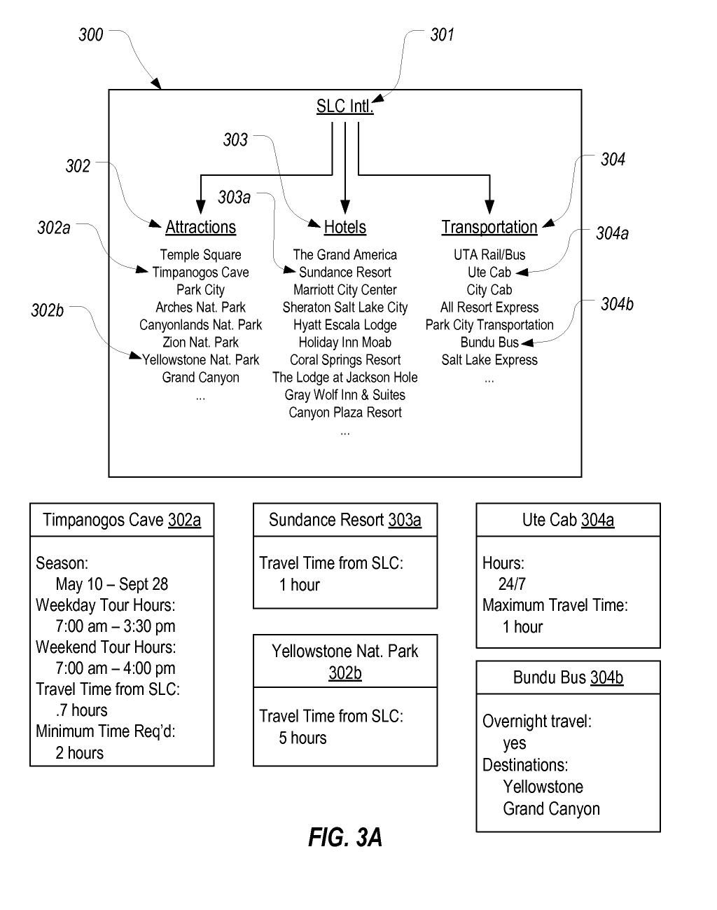

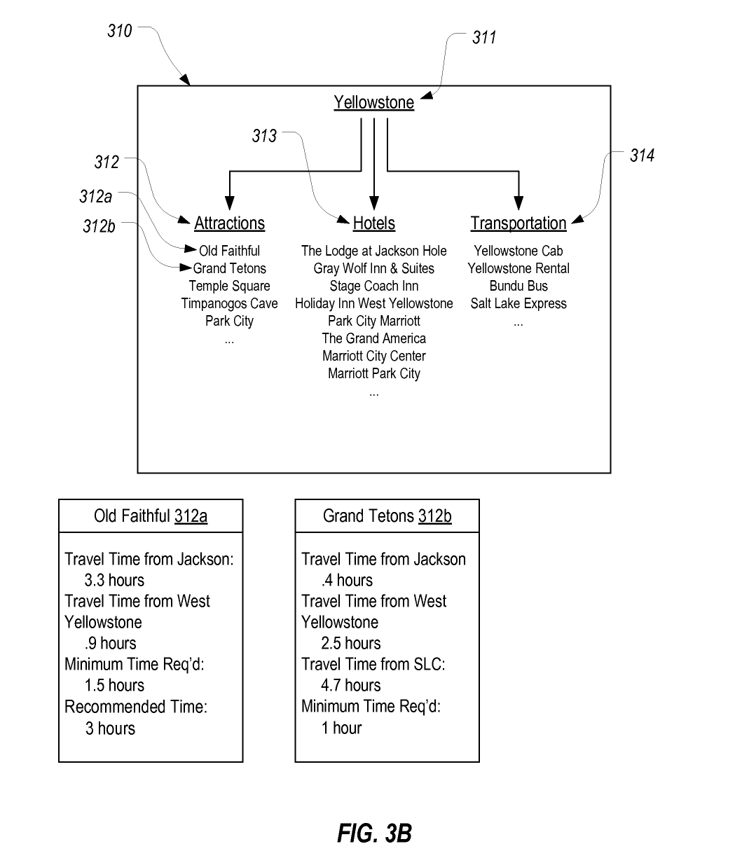

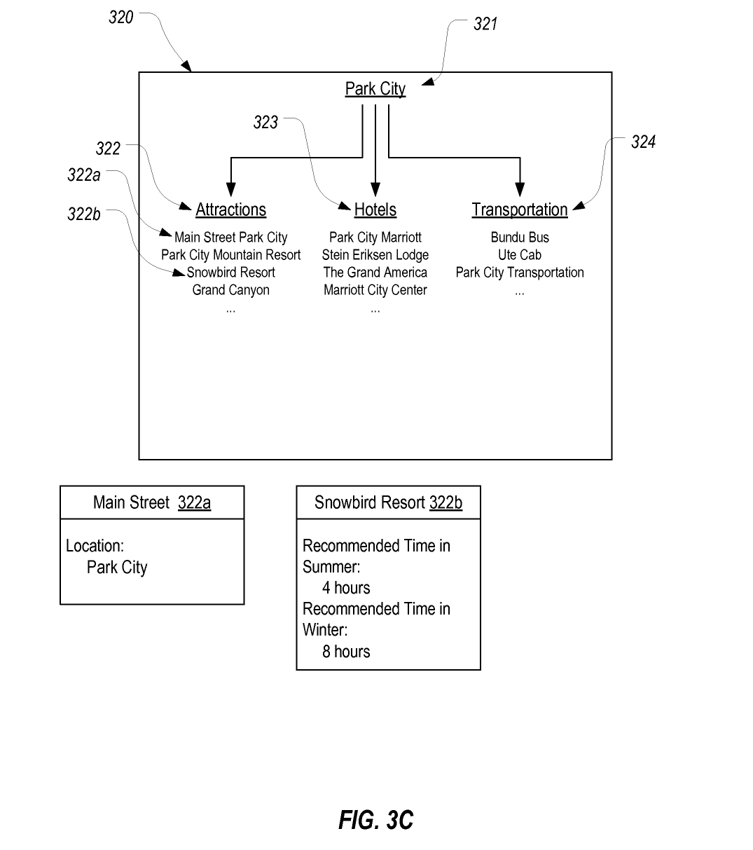

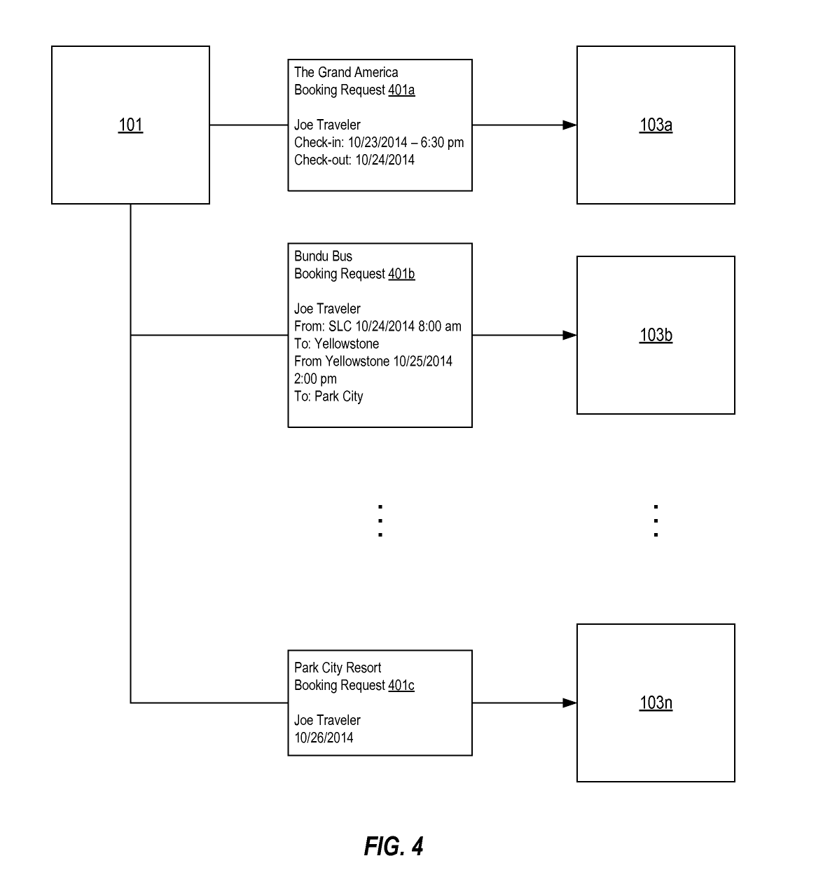

FIGS. 2A-2K illustrate a series of webpages of an example website 200 that can be displayed to assist the user in interactively scheduling an itinerary. Website 200 can be provided by server system 101 for access by user computing device 102. Alternatively, server system 101 could provide a mobile application or other type of application which provides an interface similar to website 200. FIGS. 3A-3C illustrate example data structures 300, 310, 320 that can be employed during the process depicted in FIGS. 2A-2K. Website 200 is intended merely to serve as one example of a user interface that can be presented to the user. Many other suitable interfaces and user interface constructs could equally be employed. The present invention is primarily directed to the underlying functionality which identifies suitable destinations and modes of transportation to present to the user at various times during the interactive process. Data structures 300, 310, 320 are also intended to serve as generalized examples, and any suitable data structure or structures could be employed.

FIG. 2A illustrates an initial screen that can be displayed within website 200 to receive user input of the starting point (or starting location) 200a, date 200b, and time 200c to be used for the itinerary. In this specification, the starting point can be any location (including a destination) from which a user may travel to reach a destination. In the example shown in FIG. 2A, the user has input a starting point of Salt Lake International Airport with an arrival date and time of Oct. 23, 2014 at 6:00 PM local time. This input defines the first location (or destination) and the user will be at this first location which will be used to identify which destinations will be recommended as the next destination in the itinerary. This input can also be used to identify which modes of transportation will be presented as possible modes of transportation for travelling to the next destination.

FIG. 3A illustrates a data structure 300 that can be stored and used by server system 101 in conjunction with the user input of the starting point 200a, date 200b, and time 200c, and possibly other user input, to identify destinations to recommend as the next destination in the itinerary, and in some embodiments, to identify modes of transportation for reaching the next destination. Data structure 300 is structured hierarchically with Salt Lake International Airport 301 being the top node of the hierarchy. This is only one possible organization for a suitable data structure and should not be viewed as limiting the invention. A hierarchical structure has been chosen to illustrate that the decision of which destinations or modes of transportation to recommend is based on a single starting location.

The hierarchy depicted in data structure 300 includes an attractions node 302 and a hotels node 303. For ease of illustration, the attractions node 302 and the hotels node 303 have been separated even though for purposes of this specification each type of attraction or hotel will be commonly referred to as a destination. As stated above, other types of destinations may also be included in data structure 300. The hierarchy also includes a transportation node 304. Each of nodes 302, 303 includes a number of destinations that may be considered as candidates to recommend as a next destination when the starting location is Salt Lake International Airport (or, more generally, Salt Lake City). For example, attractions node 302 includes the destinations Timpanogos Cave 302a and Yellowstone National Park 302b, while hotels node includes the destination Sundance Resort 303a. Similarly, transportation node 304 includes a number of modes of transportation that are available from Salt Lake International Airport including Ute Cab 304a and Bundu Bus 304b.

For each destination and mode of transportation, server system 101 can store information that identifies various criteria that can be used to determine whether the destination or mode of transportation will be recommended to a particular user based at least in part on a starting location of the user. For ease of explanation, this information will be described as being part of the corresponding data structure 300, 310, or 320. For example, the Timpanogos Cave destination 302a includes information defining its season (May 10-September 28), its weekday tour hours (7:00 am-3:30 pm), its weekend tour hours (7:00 am-4:00 pm), its travel time from Salt Lake International Airport (0.7 hours), and a recommended minimum time to spend at the destination (2 hours). Many other types of information can also be stored for a destination. The type of information that may be stored may depend on the type of destination. In the case of the Timpanogos Cave destination 302a, a larger amount of information may be provided since the cave cannot be visited at certain times of the year and at certain times of the day, and because there is a minimum amount of time required to visit the cave. In contrast, the Sundance Resort destination 303a only includes information defining its distance from Salt Lake International Airport (1 hour) since the destination is listed as a hotel that would be available 24 hours a day each day of the year. Similarly, the Yellowstone National Park destination 302b only includes information defining its distance from Salt Lake International Airport (5 hours). In this case, because Yellowstone National Park is a general area that can be visited at any time with few constraints, no additional information may be provided.

Although FIG. 3A indicates that the destinations specifically define a distance from Salt Lake International Airport, in some embodiments, the destinations may instead define their location (e.g., their address). Server system 101 could then calculate the distance (or travel time) from a starting point (e.g., by knowing the address of the starting point). This may facilitate using the same data structure for a destination for different starting locations. For example, the Yellowstone National Park destination 302b may define an address so that the same data structure 302b can be easily used when the starting point is Salt Lake City or Helena.

Each mode of transportation defines information that can be used to determine whether the mode of transportation would be available based on the user input of the starting point 200a, date 200b, and time 200c. As with destinations, many different types of information can be stored for a mode of transportation with the type of information varying based on the particular mode of transportation. In the case of the Ute Cab mode of transportation 304a, the hours of operation (24/7) and the maximum one-way travel time (1 hour) is provided. In the case of the Bundu Bus mode of transportation 304b, an indication that overnight travel is available and the destinations to which the bus travels are provided.

It is again noted that the hierarchical structure depicted in FIG. 3A is just one example of how the information about destinations can be structured. In this hierarchical structure, the destination's relevance to a particular starting location is identified by the destination's inclusion in the hierarchy below the starting location. Alternatively, rather than employing a hierarchical structure, each destination can include information which defines each starting location for which the destination should be considered as a candidate for the next destination. In such cases, server system 101 could identify destinations relevant to a starting location by identifying which destinations list the starting location.

To summarize, server system 101 can store information about many different destinations/modes of transportations including information which defines whether a destination/mode of transportation is relevant to a particular starting location. With this information and user input which identifies the user's starting location, date, and time, server system 101 can provide recommendations for the user's next destination as well as recommendations for the modes of transportation available to reach the next destination.

In some embodiments, the information stored by server system 101 about a destination or mode of transportation can be received from the destination or transportation provider. For example, an agent or employee of Timpanogos Cave (i.e., the National Park Service) may provide the information (e.g., via provider systems 103a-103n) included in destination 302a. Alternatively, a local or other person that is familiar with the destination or mode of transportation may provide the information. Further, in some cases, user reviews or feedback could be used to update or increase the amount of information stored for a particular destination that the user visited. In this way, it is more likely that the information maintained and used by server system 101 will be highly accurate and suitable for use in assisting the user in scheduling a desirable and feasible itinerary.

FIGS. 2B-2K illustrate an itinerary scheduling interface that can be provided by website 200 to assist the user in identifying destinations in an iterative manner. FIG. 2B represents the state of the itinerary scheduling interface that can be displayed after the user has input the starting point 200a, date 200b, and time 200c. Because the starting point 200a is Salt Lake International Airport, server system 101 can access data structure 300 to identify the potential candidates for the next destination in the itinerary. In most situations, not all destinations that are included in data structure 300 (or that are identified as being relevant to Salt Lake International Airport as the starting point) will be suitable as a next destination. To determine which destinations are suitable, server system 101 employs the user's starting date 200b and time 200c and the information stored for each destination to identify suitable next destinations.

Based on the user's starting date of October 23, there may be some destinations that are not suitable as the next destination. For example, if a destination is not open or accessible on October 23, it may be identified as unsuitable. Similarly, based on the user's starting time of 6:00 pm, there may be many destinations that are not suitable as the next destination. For example, it may not be possible to travel to the destination within a reasonable time on the starting date (e.g., before the destination closes or before some reasonable time such as 10:00 pm). With reference to FIG. 3A, server system 101 may identify based on the user's starting date 200b and/or starting time 200c that the Timpanogos Cave destination 302a is not suitable because the cave is not open on October 23 and, even if it were, the cave is not available for tours after 3:30 pm on weekdays. For these reasons, server system 101 will not recommend the Timpanogos Cave destination as a potential next destination in the user's itinerary.

Returning to FIG. 2B, server system 101 has recommended a number of destinations as potential next destinations in the user's itinerary. As shown, a recommendation 202e of Yellowstone National Park as the next destination is displayed. Even though the Yellowstone National Park destination 302b identifies a travel time of 5 hours from Salt Lake International Airport to Yellowstone National Park (which would result in the user arriving at Yellowstone at 11:00 pm at the earliest), server system 101 may still include recommendation 202e based on various criteria. For example, the Bundu Bus mode of transportation 304b indicates that it provides overnight travel from Salt Lake International Airport to Yellowstone National Park. Therefore, server system 101 can determine that it is suitable to recommend Yellowstone as the next destination since the user can travel overnight and arrive on the morning of October 24. Accordingly, in addition to recommendation 202e, server system has also displayed recommendation 203a for the Bundu Bus mode of transportation. Server system 101 may also include recommendation 202f for Arches National Park for similar reasons. In some embodiments, the information stored for a destination may include an indication of whether the destination should be recommended in situations where overnight travel would be required for the destination to be the next destination.

FIG. 2B also shows that a recommendation 202a of Temple Square as the next destination has been included. Temple Square, which is located 10 minutes from Salt Lake International Airport, may be included as a recommended next destination in this scenario since the user can easily reach Temple Square and spend sufficient time at Temple Square based on the starting point and time. For example, server system 101 may store information about the Temple Square destination indicating that it is 10 minutes from the airport, is open 7 days a week, and that it is recommended to spend at least 2 hours at the destination. Based on this information and the user's starting time of 6:00 pm, server system can identify that it would be suitable for the user to visit Temple Square on the night of October 23.

FIG. 2B also includes recommendation 202b for The Grand America destination (a hotel), recommendation 202c for the Marriott City Center destination, and recommendation 202d for the Holiday Inn Moab destination. Each of these destinations may be recommended as the next destination based on the user's starting time of 6:00 pm since it is reasonable that the user may desire to go directly to a hotel from the airport. Both The Grand America and the Marriott City Center are located in Salt Lake City and would therefore be suitable destinations given the Salt Lake International Airport starting point. Also, the Holiday Inn Moab, which is located 3.5 hours from the airport may be recommended since the user may be interested in visiting Moab. In some embodiments, the information stored about a destination can include an indication of the latest starting time for which the destination should be considered as a suitable next destination. For example, server system 101 may store information about the Holiday Inn Moab which indicates that it should only be considered a suitable next destination if the starting time is prior to 6:30 pm. As stated above, such information can be provided by the destination, those familiar with the destination, or previous visitors to the destination to ensure that the information is accurate and helpful in the itinerary scheduling process.

FIG. 2B also includes a recommendation 202g for the Grand Canyon. However, recommendation 202g is grayed out to indicate that it is not a suitable next destination based on the starting point, date, and time. For example, the information stored by server system 101 for the Grand Canyon destination may indicate that 6:00 pm is too late in the day to begin travelling to the Grand Canyon. However, server system 101 may be configured to allow recommendation 202g for the Grand Canyon to be displayed to inform the user that it is possibility to visit the Grand Canyon at a later time during the itinerary. In this way, the destination can be promoted to encourage the user to find a way to work the destination into the itinerary.

FIG. 2C represents the state of the itinerary scheduling interface that can be displayed after the user has selected one or more next destinations. In this example, it is assumed that the user has selected recommendation 202a for the Temple Square destination as well as recommendation 202b for The Grand America destination. Therefore, the itinerary scheduling interface has been updated to include selected destinations 204a and 204b. Server system 101 can include logic for determining whether more than one selected destination can overlap such as is shown in FIG. 2C with selected destinations 204a and 204b overlapping. In this case, because selected destination 204a is The Grand America hotel and selected destination 204b is the nearby Temple Square attraction, it is possible that the user can visit Temple Square while staying at The Grand America. In some embodiments, server system 101 can determine that this overlap is allowed based on Temple Square's distance from The Grand America and based on the fact that one of the overlapping destinations is a hotel as defined in the information stored by server system 101 for each destination.

In some embodiments, the itinerary scheduling interface can be configured to allow the user to drag and drop recommendations onto the interface at particular time slots. Also, once a recommendation is dropped onto the interface, the user may be able to lengthen the width of the recommendation (i.e. the recommendation icon) to identify how long the user plans to stay at the destination. For example, referring to FIG. 2C, the user may be able to drag selected destination 204a across multiple nights to indicate that the user plans to stay at The Grand America for multiple nights. Similarly, the user may be able to drag selected destination 204b forward or backward to indicate an intent to remain at Temple Square for a longer or shorter duration than whatever default duration is initially provided.

In embodiments where the user can drag and drop recommendations onto the interface or otherwise customize the placement of a recommendation within the itinerary, server system 101 may be configured to cause the icon for the recommendation to change appearance when placed over or extended/retracted to a time slot when the destination would not be suitable. For example, the icon for destination 204b could be grayed out when placed in a time slot between 9:00 pm and 9:00 am to indicate that Temple Square is not a suitable destination between these hours since it is not open. Similarly, the minimum width of the icon could be limited to correspond with the minimum amount of time that is necessary/recommended to visit the destination (e.g., 2 hours for Timpanogos Cave). Further, the placement of an icon for a destination can be limited based on the amount of time that is required to travel to the destination. For example, if it requires 5 hours to travel to the destination, the icon for the destination can be prevented from being placed closer than 5 hours to the previous location (or otherwise updated to indicate that insufficient travel time has been allotted).

Once the user has specified a next destination, server system 101 can then repeat the above-described process but with the next destination being treated as the starting point. In other words, since the next destination in FIG. 2C is The Grand America and the user has indicated that he will remain at The Grand America until the morning of October 24, The Grand America can then be treated as the starting point for identifying suitable next destinations. To simplify processing, rather than treating The Grand America specifically as the starting point, the location of The Grand America, which in this case is Salt Lake City, can be treated as the starting point. Given that Salt Lake International Airport is in Salt Lake City, and for ease of illustration, data structure 300 will again be used to describe the process of identifying suitable next locations based on the current location (or new starting point) of The Grand America.

Accordingly, in FIG. 2C, the recommendations for the next destination have been updated to remove the current destination, The Grand America, as well as the already scheduled location, Temple Square. Although not shown, other recommendations could be added to the interface including those relevant to Salt Lake City as the starting point which may not have been recommended previously due to the original starting time of 6:00 pm. In other words, now that the starting time is the morning of October 24, server system 101 can evaluate the relevant destinations in data structure 300 to identify which destinations are suitable next destinations based on a starting point of Salt Lake City, a starting date of October 24, and a starting time in the morning (e.g., 9:00 am or whatever time was specified by the user). For example, although not shown, a destination that is not open until 5:00 pm may not be included in FIG. 2C. In FIG. 2C, recommendation 202g in no longer grayed out to indicate that the Grand Canyon is a suitable next destination based on the current starting point and time.

FIG. 2D includes a selected destination 204c for Yellowstone National Park indicating that the user has selected recommendation 202e as the next destination. As shown, selected destination 204c has been placed in the interface in the appropriate time slot to account for the travel time between The Grand America and Yellowstone National Park (i.e., five hours after leaving The Grand America). As stated above, the placement or adjustment of the icon for selected destination 204c can be limited based on the required travel time.

FIG. 2D also indicates that server system 101 has prompted the user to identify how long the user would like to stay at Yellowstone National Park. With some destinations, such as general locations like a national park, there may be a wide array of durations that users can or would like to stay at the destination. In such cases, server system 101 may guide the user through the process of scheduling the appropriate duration for the visit. With other destinations, there may be a set duration of time for the visit such as when the destination involves a guided tour. This type of information can be stored by server system 101 to facilitate providing such guidance.

FIG. 2E indicates that the user has specified a desire to stay at Yellowstone National Park until midday of the following day. Because Yellowstone is an attraction and the user has indicated a desire to stay overnight at the attraction, server system 101 can recommend a number of destinations for overnight accommodations including The Lodge at Jackson Hole destination 202g and the Gray Wolf Inn & Suites destination 202h. Also, because travel will be required to reach Yellowstone, server system 101 can recommend a number of modes of transportation including the Bundu Bus mode of transportation 203a and the Salt Lake Express mode of transportation 203c.

Each of the recommendations in FIG. 2E can be based on information stored by server system 101 such as in data structure 310. For example, because the user has indicated that the next location is Yellowstone, server system can employ data structure 310 to identify destinations that are relevant to Yellowstone as the starting point in the same manner as described above when Salt Lake City served as the starting point. Similarly, server system 101 can employ information stored in either or both data structure 300 and data structure 310 to identify transportation that is available between Salt Lake City and Yellowstone.

As shown in FIG. 3B, data structure 310 includes Yellowstone 311 at the top of the hierarchy which attractions node 312, hotels node 313, and transportation nodes 314 positioned at a next level of the hierarchy. Attractions node 312 includes the Old Faithful destination 312a and the Grand Tetons destination 312b. Server system 101 also stores information describing criteria that can be used to determine whether to recommend any of the destinations or modes of transportation based on Yellowstone being the starting point and any specified starting date or time. For example, for the Old Faithful destination 312a, server system 101 stores information defining a travel time from Jackson and West Yellowstone to Old Faithful, a minimum time that should be allotted to spend at Old Faithful, and a recommended amount of time to spend at Old Faithful. Similarly, for the Grand Tetons destination 312b, server system 101 stores travel times to the Grand Tetons from Jackson, West Yellowstone, and Salt Lake City as well as a minimum amount of time that should be allotted for visiting the Grand Tetons.

FIG. 2F indicates that the user has selected recommendation 203a for the Bundu Bus mode of transportation. Accordingly, selected transportation arrow 205a has been added to the interface indicating Bundu Bus as the mode of transportation from The Grand America (or generally, from Salt Lake City) to Yellowstone. FIG. 2F also illustrates that selected destination 204d has been added to the interface indicating that the user has selected recommendation 202h for the Gray Wolf Inn & Suites for accommodations for the night of October 24.

Since Yellowstone is a general destination that spans a large area (which can be specified in the information stored by server system 101 about the Yellowstone destination), server system 101 can further prompt the user to identify any additional destinations or modes of transportation while at Yellowstone. For example, as shown in FIG. 2F, server system 101 has presented recommendation 202j for Old Faithful and recommendation 202k for the Grand Tetons. Server system 101 has also presented recommendation 203d for the Yellowstone Cab mode of transportation and recommendation 203e for the Yellowstone Rentals mode of transportation.

Because the user has specified that he will be staying in the Gray Wolf Inn & Suites while visiting Yellowstone and because Yellowstone covers a large area, the recommendations included in FIG. 2F can be based at least partially on the Gray Wolf Inn & Suites destination. For example, server system 101 may not recommend a destination within Yellowstone that is a long distance from the Gray Wolf Inn & Suites or a mode of transportation that is not available at the Gray Wolf Inn & Suites even though the destination and mode of transportation may be recommended if the user were staying at a different location (e.g., in Jackson). Accordingly, in some embodiments, server system 101 can identify recommendations based on more than one selected destination such as when two destinations overlap and one of the destinations has a specific location.

FIG. 2G indicates that the user did not select any recommendations presented in FIG. 2F representing that the user can schedule an itinerary even without identifying each destination or mode of transportation that the user may visit or use during the itinerary. For example, the user may have decided to wait until arriving at Yellowstone before identifying any particular attractions within Yellowstone or modes of transportation for arriving at those attractions.

FIG. 2G also indicates that server system 101 has prompted the user to identify the next destination after Yellowstone. The process for identifying which destinations or modes of transportation to recommend can be performed as described above but with Yellowstone (or possibly West Yellowstone, the location of Gray Wolf Inn & Suites) serving as the new starting point.

As shown in FIG. 2G, server system 101 has presented recommendation 202g for The Lodge at Jackson Hole, recommendation 202h for Gray Wolf Inn & Suites (since the user may decide that staying two nights is preferable), recommendation 202b for The Grand America (since traveling back to Salt Lake City would be reasonable based on the starting time of midday), recommendation 202i for the Marriott Park City (since Park City is within a reasonable distance from Yellowstone based on the starting time of midday), recommendation 203a for Bundu Bus and recommendation 203c for Salt Lake Express (which are both available for traveling back to Salt Lake City). Of course, recommendations for other destinations may also be presented including destinations in Montana or Idaho. In some embodiments, the user may be prompted to input a final destination and final time (e.g., a departure airport and date) which can be used by server system 101 to customize recommendations so that the user does not receive recommendations for destinations that are a long distance from the final destination. In some embodiments, server system can be configured to employ the starting point (e.g., the airport of arrival) as the default final destination. For example, server system 101 may have selected recommendations 202b, 202i, 203a, and 203c based on an assumption/knowledge that the user's final destination is Salt Lake International Airport on October 26.

FIG. 2H indicates that the user has selected recommendation 202i for the Marriott Park City destination. Accordingly, selected destination 204e has been added to the interface spanning the night of October 25. FIG. 2H also indicates that the user has selected recommendation 203a for the Bundu Bus mode of transportation for traveling from Yellowstone to Park City. Accordingly selected transportation arrow 205b has been added to the interface between Yellowstone and the Marriott Park City.

FIG. 2H also indicates that server system 101 has prompted the user to select the next destination. Because the current selected destination 204e is in Park City, data structure 320 can be used to identify which destinations and modes of transportation are recommended. As shown in FIG. 3C, data structure 320 includes Park City 321 at the top of the hierarchy with attractions node 322, hotels node 323, and transportation node 324 at a lower level. Attractions node 322 includes various destinations including the Main Street Park City destination 322a and the Snowbird Resort destination 322b.

FIG. 2H shows that server system 101 includes information about the destinations and modes of transportation relevant to Park City (many of which may be the same as those relevant to Salt Lake City). For example, for the Main Street Park City destination 322a, server system 101 includes information identifying that the destination is in Park City. The fact that no additional information is included for this destination may indicate that it is a general attraction with little or no constraints. For the Snowbird Resort destination 322b, server system 101 stores information identifying the recommended amount of time to spend at the destination in both winter and summer More time may be recommended in winter due to the fact that it is recommended that the Snowbird Resort be visited for skiing in the winter time.

In FIG. 2H, server system 101 has presented recommendation 202l for the Park City Resort destination, recommendation 202m for the Main Street Park City destination, and recommendation 202n for the Snowbird Resort destination. Each of these recommendations may be selected based on the current selected destination of the Marriott Park City. Server system 101 has also presented recommendation 203b for the Ute Cab mode of transportation and recommendation 203f for the Park City Transportation mode of transportation. Each of these recommendations can be selected based on the information stored by server system 101 about the destinations and modes of transportation as well as the user input of the current selected destination (or current starting point) and the date and time when the user will be at the current selected destination.

Because the user will be in Park City on the morning of October 26, many different destinations can be recommended both in and around Park City including those that require travel throughout the day. However, server system 101 may choose to not recommend or deemphasize any recommendations that require substantial travel since the user has just selected to travel a long distance the day before. Also, if the user had already specified his departure location, date, and time (which for this example is assumed to be Salt Lake City in the evening of October 26), server system 101 can account for this departure location, date, and time when making recommendations.

Because the user will be departing from Salt Lake International Airport in the evening, server system 101 has identified recommendations for destinations that are close to the Marriott Park City. For example, each of recommendations 202l, 202m, and 202n are for destinations that are close to Park City and Salt Lake International Airport and can be visited within a day.

Server system 101 can be configured to account for subsequent destinations when making recommendations even when the subsequent destination is not the final destination. For example, a user may desire to not schedule the itinerary in sequential order from the first destination to the last destination. Instead, the user may decide to initially select one or more destinations at particular times of the itinerary and plan around these destinations. Using the example above, the user may decide to schedule the trip to Yellowstone before scheduling any other destinations. In such cases, server system 101 can recommend destinations prior to the trip to Yellowstone that are feasible to visit within the window between arriving at Salt Lake International Airport and traveling to Yellowstone. For example, in such a case, server system 101 would not recommend travelling to Arches National Park from Salt Lake International Airport because it would not be feasible to do so before visiting Yellowstone.

In instances where the user selects a destination in a non-sequential manner, server system 101 can still assist the user in identifying an appropriate date and/or time to visit the destination using information stored about the destination and possibly one or more other previously scheduled or specified destinations (e.g., a starting and/or ending destination for the itinerary).

FIG. 2I includes selected destination 204f indicating that the user has selected recommendation 202l for the Park City Resort. For this example, it will be assumed that data structure 320 does not include information defining a minimum amount of time that should be spent at the Park City Resort. Therefore, in FIG. 2I, server system 101 has again prompted the user to select from among a number of recommended destinations. Because server system 101 knows that the user's departure time is shortly after the scheduled visit to the Park City Resort destination, server system 101 may only provide recommendation 202m to visit the Main Street Park City destination along with various recommendations for modes of transportation. In FIG. 2I, server system 101 has also provided recommendation 206 for Salt Lake International Airport to allow the user to complete the itinerary by selecting the final destination as the next destination.

FIG. 2J illustrates that the user has selected recommendation 206 and therefore selected destination 207 for Salt Lake International Airport has been added to the itinerary. In FIG. 2J, server system 101 has also provided various recommendations 203b, 203f for modes of transportation from Park City to the airport.

FIG. 2K illustrates that the user has selected recommendation 203b for the Ute Cab mode of transportation. Accordingly, selected transportation arrow 205c has been added to the itinerary. FIG. 2K also includes a confirm button that the user can select to confirm the itinerary. Prior to confirming, server system 101 can allow the user to modify any selected destinations and modes of transportation including by replacing them or by adjusting the beginning and ending times for the destinations. As the user makes any modifications, server system 101 can access the pertinent stored information to ensure that the itinerary would still be feasible with the modifications.

The above description has provided many different examples of the type of information that can be stored about a destination or a mode of transportation. Additionally, many other types of information can be provided. In short, any information that can be useful for determining whether a particular destination can be visited at a particular time and from a particular starting location can be used. Server system 101 can be configured to consider each of these different types of information when determining whether to recommend a destination or mode of transportation and when identifying whether a selected destination or mode of transportation is feasible within the time slot specified by the user (e.g., when the user makes adjustments to one or more destinations or modes of transportation within the itinerary).

Once the user has completed the process of scheduling an itinerary (e.g., when the user selects confirm in FIG. 2K, server system 101 can initiate a process of booking one or more of the destinations or modes of transportation. For example, because the user's itinerary has selected The Grand America and Temple Square for the night of October 24, server system 101 can send a reservation requests to the appropriate provider systems 103a-103n to reserve a room and a tour for the user. Similar reservation requests can be sent to reserve any other destination or mode of transportation as necessary.

In some embodiments, after an itinerary has been created, server system 101 can store the itinerary so that the full itinerary or portions of the itinerary can be presented to subsequent users. In this way, subsequent users can select an itinerary or portions of an itinerary without needing to go through the iterative process described above. In some embodiments, server system 101 can prompt the user, after the user has completed his travel, to confirm whether the itinerary was feasible and/or desirable. Any indication that the itinerary was not feasible or desirable or that any portion of the itinerary was not feasible or desirable can be used to update the information stored by server system 101 regarding the pertinent destination(s) and/or mode(s) of transportation to increase the effectiveness of the itinerary scheduling process. Server system 101 can also prompt the user to review a destination or mode of transportation. Reviews provided by users can be used to determine whether to recommend a destination or mode of transportation (e.g., by not recommending a poorly reviewed destination even if it is suitable as a next destination), or can be displayed with a recommendation to encourage the users to select destinations and modes of transportations with good reviews.

Although the itinerary scheduling process was described as relying primarily on the starting point, date, and time of the user to identify suitable recommendations, in some embodiments, the user may be prompted to identify one or more interests or required destinations/modes of transportation. In such cases, the selection of recommendations can be based on such interests or required destinations/modes of transportation. For example, if the user expresses an interest in outdoor destinations, server system 101 may filter out suitable destinations that are not outdoors. Similarly, if the user specifies a particular destination that must be included in the itinerary, server system 101 can filter out any destinations or modes of transportation that are not feasible with the particular destination.

In some embodiments, server system 101 may maintain a count of the number of users that selected a particular destination or mode of transportation when the particular destination or mode of transportation was recommended. Such a count can assist future users in identifying destinations or modes of transportation that are most popular which can assist users who are unfamiliar with an area in identifying the must-see destinations or preferred modes of transportation.

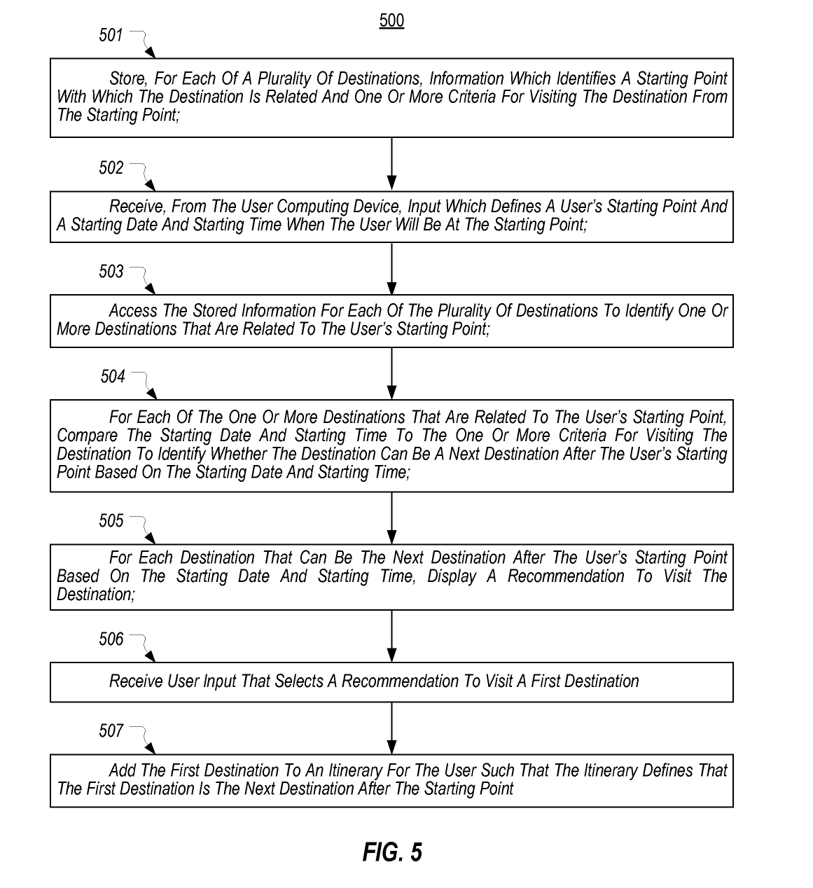

FIG. 5 illustrates a flowchart of an example method 500 for interactively scheduling an itinerary. FIG. 5 will be described with reference to computer environment 100, website 200 depicted in FIGS. 2A-2K, and data structures 300, 310, 320 depicted in FIGS. 3A-3C.

Method 500 includes an act 501 of storing, for each of a plurality of destinations, information which identifies a starting point with which the destination is related and one or more criteria for visiting the destination from the starting point. For example, server system 101 can store data structure 300, 310, or 320.

Method 500 includes an act 502 of receiving, from the user computing device, input which defines a user's starting point and a starting date and starting time when the user will be at the starting point. For example, server system 101 can receive starting point 200a, date 200b, and time 200c from user computing device 102. Also, server system 101 can receive user input that selects a destination for inclusion in an itinerary (e.g., the selected Grand America destination 204a or the selected Yellowstone destination 204c) and the destination as well as when the user plans to be at the destination can serve as the starting point, date, and time.

Method 500 includes an act 503 of accessing the stored information for each of the plurality of destinations to identify one or more destinations that are related to the user's starting point. For example, server system 101 can access data structure 300, 310, or 320 to identify destinations that are related to the user's starting point.

Method 500 includes an act 504 of, for each of the one or more destinations that are related to the user's starting point, comparing the starting date and starting time to the one or more criteria for visiting the destination to identify whether the destination can be a next destination after the user's starting point based on the starting date and starting time. For example, starting date 200b and starting time 200c can be compared to destinations 302a, 302b, 303a, etc. to determine if any of the destinations can be a next destination after starting point 200a. A similar comparison can be performed when another destination such as destinations 204a-204f are treated as the starting point.

Method 500 includes an act 505 of, for each destination that can be the next destination after the user's starting point based on the starting date and starting time, displaying a recommendation to visit the destination. For example, appropriate ones of recommendations 202a-202n can be displayed.

Method 500 includes an act 506 of receiving user input that selects a recommendation to visit a first destination. For example, server system 101 can receive user input from user computing device 102 that selects one of representations 202a-202n.

Method 500 includes an act 507 of adding the first destination to an itinerary for the user such that the itinerary defines that the first destination is the next destination after the starting point. For example, one of selected destination 204a-204f can be added to the itinerary as the next destination.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A method, performed by a server computing system in communication with a user computing device, for interactively scheduling an itinerary, the method comprising:
storing, for each of a plurality of destinations, information which identifies a starting point with which the destination is related and one or more criteria for visiting the destination from the starting point;
receiving, from the user computing device, input which defines a user's starting point and a starting date and starting time when the user will be at the starting point;
accessing the stored information for each of the plurality of destinations to identify one or more destinations that are related to the user's starting point;
for each of the one or more destinations that are related to the user's starting point, comparing the starting date and starting time to the one or more criteria for visiting the destination to identify whether the destination can be a next destination after the user's starting point based on the starting date and starting time;
for each destination that can be the next destination after the user's starting point based on the starting date and starting time, displaying a recommendation to visit the destination;
receiving user input that selects a recommendation to visit a first destination; and
adding the first destination to an itinerary for the user such that the itinerary defines that the first destination is the next destination after the starting point.

2. The method of claim 1, wherein the one or more criteria for visiting the first destination comprise a travel time from the starting point to the first destination.

3. The method of claim 1, wherein the one or more criteria for visiting the first destination comprise a duration of time required or recommended to visit the first destination.

4. The method of claim 1, wherein the one or more criteria for visiting the first destination comprise an indication of when the first destination is available to be visited.

5. The method of claim 1, further comprising:
storing, for each of a plurality of modes of transportation, information which identifies a starting point with which the mode of transportation is related and one or more criteria defining the availability of the mode of transportation from the starting point;
in response to receiving the input which defines the user's starting point and the starting date and starting time, accessing the stored information for each of the plurality of modes of transportation to identify one or more modes of transportation that are related to the user's starting point;
for each of the plurality of modes of transportation that are related to the user's starting point, identifying, from the one or more criteria defining the availability of the mode of transportation from the starting point, whether the mode of transportation is available on the starting date and at the starting time; and
for each mode of transportation that is available, displaying an indication that the mode of transportation is available.

6. The method of claim 5, wherein identifying, from the one or more criteria defining the availability of the mode of transportation from the starting point, whether the mode of transportation is available on the starting date and at the starting time comprises:
identifying whether the mode of transportation is available on the starting date and at the starting time for traveling from the starting point to the first destination.

7. The method of claim 6, wherein the one or more criteria defining the availability of the mode of transportation from the starting point identify one or more destinations to which the mode of transportation travels from the starting point.

8. The method of claim 6, wherein the one or more criteria defining the availability of the mode of transportation from the starting point identify hours of operation of the mode of transportation.

9. The method of claim 1, wherein the user's starting point comprises a destination that was previously recommended to the user and selected by the user for inclusion in the itinerary.

10. The method of claim 1, further comprising:
receiving input which defines a final destination for the user's itinerary and a date and time when the user needs to arrive at the final destination; and
wherein comparing, for each of the one or more destinations that are related to the user's starting point, the starting date and starting time to the one or more criteria for visiting the destination to identify whether the destination can be the next destination after the user's starting point based on the starting date and starting time further comprises:
comparing, for each of the one or more destination that are related to the user's starting point, the one or more criteria for visiting the destination to the final destination and the date and time when the user needs to arrive at the final destination to identify whether the destination can be the next destination after the user's starting point based on the starting date and starting time.

11. The method of claim 1, wherein adding the first destination to an itinerary for the user such that the itinerary defines that the first destination is the next destination after the starting point further comprises:
adding the first destination to a particular time slot in the itinerary; and
formatting the first destination with an indication of whether the first destination can be visited in the particular time slot.

12. The method of claim 1, wherein adding the first destination to an itinerary for the user such that the itinerary defines that the first destination is the next destination after the starting point further comprises:
identifying, from the one or more criteria for the first destination, a travel time from the starting point to the first destination; and
adding the first destination to the itinerary in a time slot that is spaced from the starting time by at least the identified travel time.

12. The method of claim 1, wherein adding the first destination to an itinerary for the user such that the itinerary defines that the first destination is the next destination after the starting point further comprises:
identifying, from the one or more criteria for the first destination, a duration of time that is recommended or required to visit the first destination; and
adding the first destination to the itinerary in a time slot having a duration at least as long as the identified duration.

13. The method of claim 1, further comprising:
identifying that a second destination of the plurality of destinations cannot be the next destination after the user's starting point based on the starting date and starting time; and
displaying a representation of the second destination that indicates that the second destination cannot be the next destination but can be a subsequent destination.

14. The method of claim 1, further comprising:
storing the itinerary; and
recommending the itinerary to another user with a starting point that matches the user's starting point.

15. The method of claim 14, wherein the itinerary is a portion of an itinerary, and wherein recommending the itinerary comprises recommending the portion of the itinerary.

16. The method of claim 1, wherein the information which identifies a starting point with which the first destination is related and one or more criteria for visiting the first destination from the starting point is received from the first destination.

17. The method of claim 1, further comprising:
creating a reservation request for the first destination based on a time slot where the first destination is positioned within the itinerary.

18. One or more computer storage media storing computer executable instructions which when executed by one or more processors implement a method for interactively scheduling an itinerary, the method comprising:
storing, for each of a plurality of destinations, information which identifies a starting point with which the destination is related and one or more criteria for visiting the destination from the starting point;
receiving, from the user computing device, input which defines a user's starting point and a starting date when the user will be at the starting point;
accessing the stored information for each of the plurality of destinations to identify one or more destinations that are related to the user's starting point;
for each of the one or more destinations that are related to the user's starting point, comparing the starting date to the one or more criteria for visiting the destination to identify whether the destination can be a next destination after the user's starting point based on the starting date;
for each destination that can be the next destination after the user's starting point based on the starting date, displaying a recommendation to visit the destination;
receiving user input that selects a recommendation to visit a first destination; and
adding the first destination to an itinerary for the user such that the itinerary defines that the first destination is the next destination after the starting point.

19. The computer storage media of claim 18, wherein the one or more criteria for visiting the first destination comprise one or more of:
a travel time from the starting point to the first destination;
a duration of time required or recommended to visit the first destination; or
an indication of when the first destination is available to be visited.

20. The computer storage media of claim 18, wherein the user's starting point comprises a destination that was previously recommended to the user and selected by the user for inclusion in the itinerary.
